(19) United States
(12) Patent Application Publication
(10) Pub. No.: US 2013/0126414 A1
(43) Pub. Date: May 23, 2013

(54) SLAG STORAGE TANK AND SLAG DISCHARGE SYSTEM

(71) Applicants: Yasuyuki Miyata, Minato-ku (JP); Yasuo Soda, Minato-ku (JP); Yoshinori Koyama, Minato-ku (JP)

(72) Inventors: Yasuyuki Miyata, Minato-ku (JP); Yasuo Soda, Minato-ku (JP); Yoshinori Koyama, Minato-ku (JP)

(21) Appl. No.: 13/812,021

(22) PCT Filed: Aug. 10, 2011
(86) PCT No.: PCT/JP2011/068300

§ 371 Date: Jan. 24, 2013

(30) Foreign Application Priority Data
Aug. 10, 2010 (JP) 2010-179875

(51) Int. Cl. F27D 15/02; F27D 15/00; B01D 37/00

(52) U.S. Cl. CPC F27D 15/02; F27D 15/00
USPC 210/323.1; 210/769

(57) ABSTRACT

A slag storage tank and a slag discharge system include a main body that stores slag, and a plurality of filters that are arranged on a wall surface of the main body and cause a liquid to selectively pass therethrough. The filters are disposed in at least a part of any cross-section perpendicular to the vertical direction of a region where the slag is stored in the main body. Accordingly, there is an effect that the slag storage tank capable of stably discharging the liquid and the slag discharge system capable of further simply and appropriately discharging the slag may be provided.

### FIELD

The present invention relates to a slag storage tank which stores and discharges slag supplied thereto and a slag discharge system having the same.

### BACKGROUND

A technique is known which generates power by driving a gas turbine using a coal gas obtained by gasifying coal. In order to gasify the coal, a coal gasification furnace is used. When the coal is gasified, slag remains as cinders in the coal gasification furnace. Such slag needs to be discharged from the coal gasification furnace. Since the slag may flow at a sufficiently high temperature, the slag is generally discharged continuously from a slag hole which is formed at the lower portion of the coal gasification furnace. A slag discharge tube which is filled with cooling water is installed below the slag hole, and the slag is discharged from the slag discharge tube after the slag is cooled and solidified by the cooling water.

As a system that discharges slag, there are systems disclosed in Patent Literature 1, Patent Literature 2, and Patent Literature 3. Any of the systems disclosed in Patent Literature 1 and Patent Literature 2 conveys solidified slag to a storage tank and the like by a belt conveyor. Further, the system in Patent Literature 3 discloses a mechanism which is disposed inside a housing and rotates a shaft provided with a plurality of flights so as to convey slag to a container. Further, the discharge system includes a slag storage tank which temporarily stores cooled slag.

### CITATION LIST

### Patent Literature

Patent Literature 1: Japanese Laid-open Patent Publication No. 2002-122319
Patent Literature 2: Japanese Laid-open Patent Publication No. 2003-88832
Patent Literature 3: Japanese Laid-open Patent Publication No. 2003-518157

### SUMMARY

### Technical Problem

Here, the discharge systems disclosed in Patent Literature 1 to Patent Literature 3 convey the slag by the belt conveyor or the screw. For this reason, there is a problem in that a degree in freedom of the configuration of the system decreases due to the limitation in the inclination angle of the conveyor or the conveyor or the screw to be disposed in a linear shape. Further, the slag may be reliably conveyed by a scraper or a scraping claw. However, there is a limitation in the conveying amount of the conveying operation using one scraper or the scraping claw, and the conveying operation is intermittently performed.

On the contrary, as the slag discharge system, system is known which mixes slag with a liquid into a slurry state and conveys (supplies) the slurry to a slag storage tank. The slag storage tank of the system includes a filter which selectively discharges the liquid included in the slurry and discharges only the liquid from the filter, thereby storing only the slag therein. Likewise, in the slag storage tank including the filter, the liquid may be unstably discharged. Further, when the liquid is unstably discharged from the slag storage tank, the discharging of the slag is also affected by the unstable discharging of the liquid.

The invention is made in view of such circumstances, and it is an object of the invention to provide a slag storage tank capable of stably discharging a liquid and a slag discharge system capable of further simply and appropriately discharging slag.

### Solution to Problem

According to an aspect of the present invention, a slag storage tank for storing slag includes: a main body which stores slag; and a plurality of filters which are arranged on a wall surface of the main body and cause a liquid to selectively pass therethrough. The filters are arranged in at least a part of any cross-section perpendicular to the vertical direction of the wall surface in a region where the slag is stored in the main body. Accordingly, it is possible to stably discharge the liquid regardless of the position of the liquid level of the liquid.

Advantageously, the slag storage tank further includes a reinforcing portion which is disposed around the outer periphery of the main body. Accordingly, it is possible to improve the strength of the system and hence to improve the durability thereof.

Advantageously, in the slag storage tank, the main body includes a plurality of surfaces, and the filters are arranged on a same surface of the main body. Accordingly, one surface may be used to discharge the liquid therefrom.

Advantageously, in the slag storage tank, the main body includes a plurality of surfaces, and the filters are arranged on the plurality of surfaces of the main body. Accordingly, it is possible to improve the degree of freedom in design of the system.

Advantageously, in the slag storage tank, a ratio of the filters arranged on the cross-section perpendicular to the vertical direction in the area where the slag is stored in the main body is in a predetermined range. Accordingly, it is possible to further stably discharge the liquid.

According to another aspect of the present invention, a slag storage tank for storing slag includes: a main body which stores slag; and a plurality of filters which are arranged on a wall surface of the main body and cause a liquid to selectively pass therethrough. Rows of the plurality of filters arranged in the vertical direction of the main body are arranged at adjacent positions in the horizontal direction of the main body, and the filters are arranged so that the positions in the vertical direction are shifted from the filters arranged in the adjacent rows. Accordingly, it is possible to stably discharge the liquid regardless of the position of the liquid level of the liquid.

According to still another aspect of the present invention, a slag discharge system includes: the slag storage tank any one of above described; a slag cooling unit which cools discharged slag; a slurry tank which stores the slag discharged from the slag cooling unit and a liquid; a slag slurry conveying unit which changes the slag stored in the slurry tank into slurry by the liquid and conveys the slurry to the slag storage tank; and a collection unit which collects the liquid discharged from the filter of the slag storage tank and supplies the liquid to the slurry tank. Accordingly, it is possible to stably discharge the liquid regardless of the position of the liquid level of the liquid. It is possible to appropriately circulate the liquid.

### Advantageous Effects of Invention

There is an effect that the slag storage tank according to the invention may stably discharge the liquid. Further, there is an effect that the slag discharge system according to the invention may simply and appropriately discharge the slag.

### BRIEF DESCRIPTION OF DRAWINGS

FIG. 1 is a schematic diagram illustrating a schematic configuration of an embodiment of a slag discharge system.

FIG. 2 is a side view illustrating a schematic configuration of a slag storage tank illustrated in FIG. 1.

FIG. 3 is a side view illustrating a side view adjacent to a side surface of the slag storage tank illustrated in FIG. 2.

FIG. 4 is a cross-sectional view taken along a line A-A of FIG. 2.

FIG. 5 is a perspective view illustrating a schematic configuration of another example of the slag storage tank.

FIG. 6 is a side view illustrating a schematic configuration of another example of the slag storage tank.

FIG. 7 is a side view illustrating a side surface adjacent to a side surface of the slag storage tank illustrated in FIG. 6.

FIG. 8 is a cross-sectional view taken along a line B-B of FIG. 6.

FIG. 9 is a perspective view illustrating a schematic configuration of the slag storage tank illustrated in FIG. 6.

FIG. 10 is a side view illustrating a schematic configuration of another example of the slag storage tank.

FIG. 11 is a side view illustrating a schematic configuration of another example of the slag storage tank.

FIG. 12 is a side view illustrating a schematic configuration of another example of the slag storage tank.

### DESCRIPTION OF EMBODIMENTS

Hereinafter, the invention will be described in detail by referring to the drawings. Furthermore, the invention is not limited to a mode for carrying out the invention below (hereinafter, referred to as an embodiment). Further, the constituents in the embodiment below include a constituent which may be easily supposed by the person skilled in the art, a constituent which has substantially the same configuration, and a constituent which is in a so-called equivalent scope. In addition, the constituents described in the embodiment below may be appropriately combined with one another.

Hereinafter, an embodiment of a slag discharge system according to the invention will be described in detail based on the drawings. Furthermore, the invention is not limited to the embodiment.

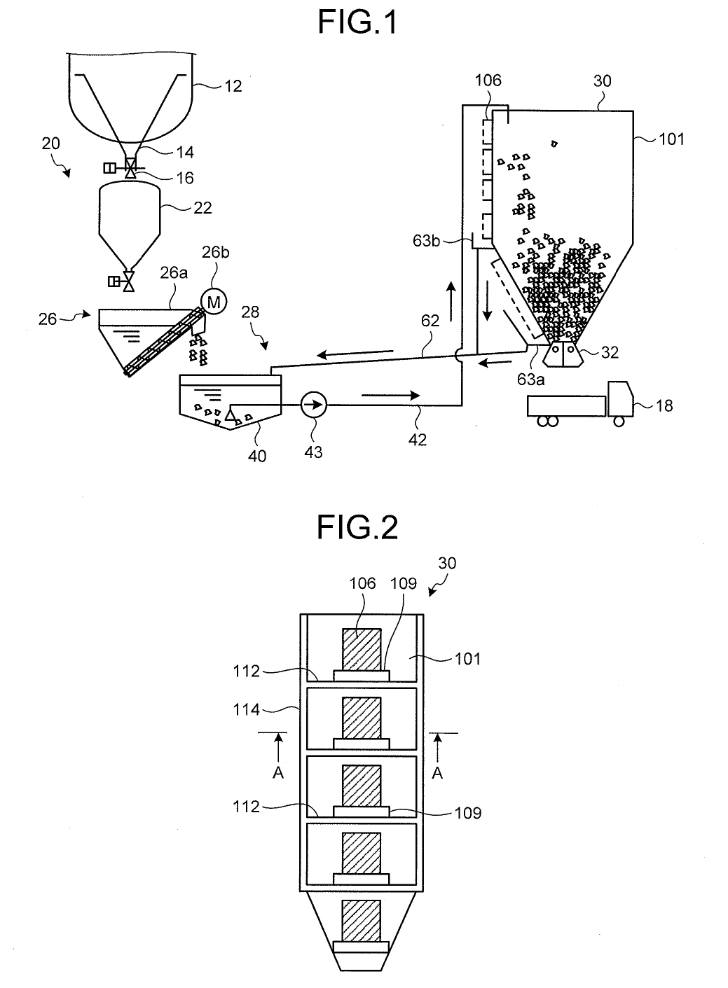

FIG. 1 is a schematic diagram illustrating a schematic configuration of an embodiment of a slag discharge system. First, a gasification furnace 12, a slag hopper 14, an opening and closing valve 16, and a conveying vehicle 18 which are arranged around a slag discharge system 20 illustrated in FIG. 1 will be described. The gasification furnace 12 gasifies a combustion material such as coal and supplies a produced gas to a combustion furnace and the like. Further, the gasification furnace 12 stores slag, which is produced when gasifying the combustion material, in a slag hopper 14 disposed at the lower portion of the gasification furnace. The slag hopper 14 is a storage mechanism, which is disposed at the lower portion of the gasification furnace 12, collects slag produced by the gasification furnace 12, and stores the slag therein. Furthermore, the slag hopper 14 is formed in a funnel shape of which the diameter decreases as it goes downward in the vertical direction, and collects the produced slag at one position by moving the slag produced by the gasification furnace 12 downward in the vertical direction. The opening and closing valve 16 is disposed at the end on the lower side of the vertical direction of the slag passage path of the slag hopper 14. The opening and closing valve 16 may start or stop an operation of discharging the slag stored in the slag hopper 14 to the slag discharge system 20 by switching the opening and closing states thereof. Furthermore, the slag which is discharged from the opening and closing valve 16 may be a solid or a fluid. Further, the slag which is discharged from the opening and closing valve 16 is basically high-temperature slag that needs to be cooled.

A conveying vehicle 18 is a vehicle which moves the slag discharged from the slag discharge system 20 to a predetermined position. As the conveying vehicle 18, a truck may be used. Furthermore, in the embodiment, a configuration is described in which the slag is discharged to the conveying vehicle 18. However, the invention is not limited thereto, and the slag may be discharged to various subjects.

Next, the slag discharge system 20 will be described. The slag discharge system 20 is a system that discharges the slag, which is produced by the gasification furnace 12 and is discharged from the opening and closing valve 16 of the slag hopper 14, to the conveying vehicle 18. The slag discharge system 20 includes a slag lock hopper 22, a slag cooling unit 26, a slag conveying unit 28, a slag storage tank 30, and a discharge port 32.

The slag lock hopper 22 is a storage portion which temporarily stores the slag, and is disposed directly below the opening and closing valve 16. The slag lock hopper 22 temporarily stores the slag discharged from the opening and closing valve 16, and then supplies the slag to the slag cooling unit 26.

The slag cooling unit 26 includes a cooling tank 26a and a conveyor 26b, and supplies the slag discharged from the slag lock hopper 22 to the slag conveying unit 28 after cooling the slag. The cooling tank 26a is a tank which stores a liquid such as water for cooling slag and is disposed directly below the slag lock hopper 22. The slag which is discharged from the slag lock hopper 22 falls into the liquid stored in the cooling tank 26a, so that the slag is cooled by the liquid. The conveyor 26b is a conveying mechanism which conveys the slag that is cooled while falling into the cooling tank 26a. A part of the conveyor 26b is disposed inside the cooling tank 26a, and moves the slag inside the cooling tank 26a while holding the slag thereon so as to be discharged to the slag conveying unit 28.

The slag conveying unit 28 is a conveying mechanism which conveys the slag discharged from the slag cooling unit 26 to the slag storage tank 30, and includes a slurry tank 40, a transport pipe 42, a slurry pump 43, a collection pipe 62, and water receiving portions 63a and 63b. The slurry tank 40 is a tank which stores water and the slag supplied from the slag cooling unit 26. The slurry tank 40 stores the slag which is dispersed in the water. The transport pipe 42 is a pipe which connects the slurry tank 40 to the slag storage tank 30. Further, the slurry pump 43 is disposed in the transport pipe 42, and forms a stream in which the water having the slag dispersed inside the slurry tank 40 flows to the slag storage tank 30 in the transport pipe 42. In this way, the slag conveying unit 28 conveys the slag dispersed in the water inside the slurry tank 40 in a slurry state to the slag storage tank 30 by the transport pipe 42 and the slurry pump 43.

The collection pipe 62 is a pipe which collects the water discharged from the slag storage tank 30, and connects the water receiving portion 63b to the slurry tank 40 by connecting the water receiving portion 63a to the slurry tank 40. The water receiving portions 63a and 63b are disposed below the water discharging portion of the slag storage tank 30, and collect the water discharged from the slag storage tank 30. The water receiving portions 63a and 63b cause the collected water to flow to the collection pipe 62. Furthermore, the water receiving portion 63a is disposed below the inclined portion of the slag storage tank 30, and the water receiving portion 63b is disposed below the perpendicular portion of the slag storage tank 30.

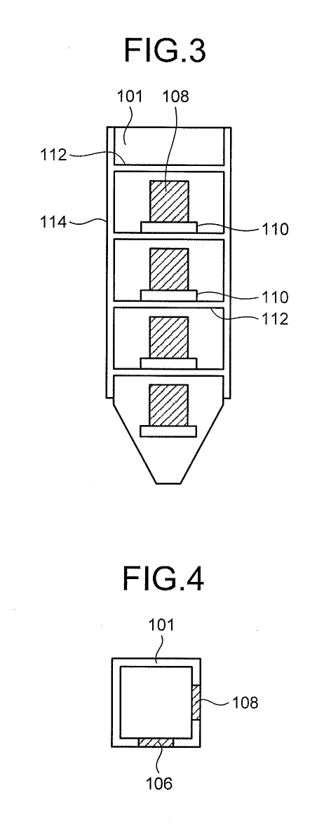

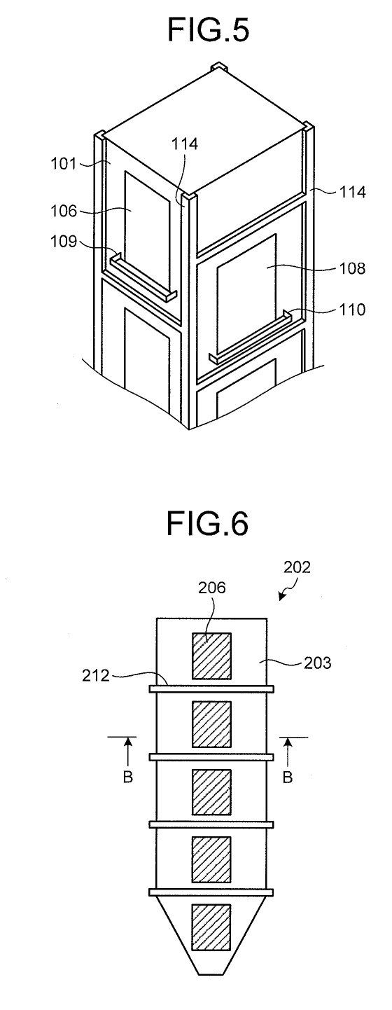

The slag storage tank 30 is a tank which stores the slag conveyed by the slag conveying unit 28. Here, FIG. 2 is a side view illustrating a schematic configuration of the slag storage tank illustrated in FIG. 1. FIG. 3 is a side view illustrating a side surface adjacent to the side surface of the slag storage tank illustrated in FIG. 2. FIG. 4 is a cross-sectional view taken along a line A-A of FIG. 2. FIG. 5 is a perspective view illustrating a schematic configuration of another example of the slag storage tank. As illustrated in FIGS. 1 to 5, the slag storage tank 30 includes a main body 101, filters 106 and 108, troughs 109 and 110, a transverse reinforcing portion 112, and a longitudinal reinforcing portion 114. The main body 101 is a hollow tower, and in the embodiment, has a barrel shape of which the cross-section (the horizontal plane) has a square shape. Then, the lower side in the vertical direction is provided with an end of which the diameter gradually decreases.

The filter 106 is a member through which the slag does not pass and the water passes, and the plurality of filters are arranged on the side surface (the wall surface) of the main body 101. The plurality of filters 106 are arranged at the respective positions of one surface of the main body 101 in the vertical direction. Further, the filter 108 is a member through which the slag does not pass and the water passes as in the filter 106, and the plurality of filters are arranged on the side surface (the wall surface) of the main body 101. The plurality of filters 108 are arranged at the respective positions of one surface adjacent to the surface provided with the filters 106 of the main body 101 in the vertical direction. Furthermore, as the filters 106 and 108, a member having a plurality of holes with a diameter that does not allow the passage of the slag and allows the passage of the water may be used. Further, the arrangement positions of the filters 108 in the vertical direction are different from those of the filters 106. That is, the filters are arranged at positions shifted from the filters 106 arranged in the adjacent rows in the vertical direction. Specifically, the filter 108 is disposed in the vertical direction so as to be positioned at a region between the filter 106 and the filter 106 adjacent to the filter 106 in the vertical direction. Furthermore, since the filter 106 and the filter 108 are just disposed at different surfaces, the respective filters may be formed by the same member.

The plurality of troughs 109 are positioned so as to correspond to the filters 106. Each trough 109 is disposed directly below the filter 106 of the main body 101. The trough 109 collects the water discharged from the filter 106 disposed directly thereabove, and conveys (discharges) the water to the water receiving portions 63a and 63b. Furthermore, a method of connecting the trough 109 to the water receiving portions 63a and 63b is not particularly limited, and a pipe may be installed which connects both constituents so that the water flows thereinto. The water discharging portion of the trough 109 may be disposed directly above the water receiving portions 63a and 63b so that the water freely falls so as to flow to the water receiving portions 63a and 63b.

The plurality of troughs 110 are positioned so as to correspond to the filters 108. Each trough 110 is disposed directly below the filter 108 of the main body 101. The trough 110 collects the water discharged from the filter 108 disposed directly thereabove, and conveys (discharges) the water to the water receiving portions 63a and 63b. Furthermore, a method of connecting the trough 110 to the water receiving portions 63a and 63b is not particularly limited, and a pipe may be installed which connects both constituents so that the water flows thereinto. The water discharging portion of the trough 110 may be disposed directly above the water receiving portions 63a and 63b so that the water freely falls so as to flow to the water receiving portions 63a and 63b.

The transverse reinforcing portion 112 is a bar-like member which is disposed in the circumferential direction of the main body 101, and the plurality of transverse reinforcing portions are arranged on the outer peripheral surface of the main body 101. Further, the longitudinal reinforcing portion 114 is disposed along four sides of the main body 101. Furthermore, both ends of the transverse reinforcing portion 112 are connected to different longitudinal reinforcing portions 114. Further, the transverse reinforcing portion 112 is disposed between the filter 106 and the filter 106 and between the filter 108 and the filter 108. Here, the transverse reinforcing portion 112 is connected to the transverse reinforcing portion 112 installed at the other surface through the longitudinal reinforcing portion 114, so that the transverse reinforcing portions are connected to each other in the circumferential direction of the main body 101. Furthermore, the arrangement position of the transverse reinforcing portion 112 is not limited as long as the transverse reinforcing portions are connected to each other in the circumferential direction of the main body 101. Furthermore, the transverse reinforcing portion 112 is disposed in a region without the filters 106 and 108.

The slag storage tank 30 has the above-described configuration. Then, when the water and the slag are supplied from the slag conveying unit 28, only the water is discharged from the filters 106 and 108 and the slag is stored in the slag storage tank. Further, as illustrated in FIGS. 2 and 3, in the slag storage tank 30, the filter 106 and the filter 108 are respectively disposed on different surfaces of the main body 101. Further, as illustrated in FIG. 4, a part of the cross-section perpendicular to the vertical direction of the main body 101 is provided with both the filter 106 and the filter 108. Accordingly, as illustrated in FIG. 5, the main body 101 is provided with the filter 106 and the filter 108 which are deviated from each other by a predetermined distance in the vertical direction. Further, the transverse reinforcing portions 112 which are installed in the respective surfaces of the main body 101 are also shifted from each other in the vertical direction so as to correspond to the displacement of the arrangement positions of the filter 106 and the filter 108. That is, the transverse reinforcing portion 112 is disposed so as not to block the filters 106 and 108.

Accordingly, in the slag storage tank 30, the filter 108 is disposed in a region without the filter 106 in the vertical direction of the slag storage region of the main body 101, and the filter 106 is disposed in a region without the filter 108. Further, the filters 106 and 108 are not blocked by the reinforcing portion. Furthermore, the slag storage region of the main body 101 indicates a region where the slag is substantially stored, and does not include a part of the upper end or the lower end of the main body 101.

The discharge port 32 is disposed at the lower end of the slag storage tank 30, and controls the execution and the stop of an operation of discharging the slag stored in the slag storage tank 30. The slag which is discharged from the discharge port 32 is discharged to the conveying vehicle 18 which stops in a standby state directly below the discharge port.

The slag discharge system 20 has the above-described configuration, and temporarily stores the slag, which is produced by the gasification furnace 12, is collected by the slag hopper 14, and is discharged from the opening and closing valve 16, in the slag lock hopper 22. The slag discharge system 20 conveys the slag stored in the slag lock hopper 22 to the cooling tank 26a of the slag cooling unit 26, cools the slag by the cooling tank 26a, and then conveys the slag to the slurry tank 40 by the conveyor 26b.

The slag discharge system 20 conveys the slag stored in the slurry tank 40 to the slag storage tank 30 together with the water by the transport pipe 42 and the slurry pump 43. Further, the water which is conveyed to the slag storage tank 30 together with the slag is discharged from the filters 106 and 108 and falls to the troughs 109 and 110. The water which falls to the troughs 109 and 110 is conveyed to the water receiving portions 63a and 63b, and is conveyed to the slurry tank 40 through the collection pipe 62.

The slag discharge system 20 continues the conveying of the above-described slag, and stops the conveying of the slag when predetermined slag is conveyed to the slag storage tank 30. Subsequently, the slag discharge system 20 discharges the slag from the discharge port 32 to the conveying vehicle 18 when the water inside the slag storage tank 30 is discharged from the filters 106 and 108 to the troughs 109 and 110 and the slag inside the slag storage tank 30 is dried. The conveying vehicle 18 loads the slag thereon and conveys the slag to a predetermined point. Furthermore, the conveying vehicle 18 sequentially moves to a position directly below the discharge port 32, and loads the slag thereon. Then, the conveying vehicle 18 moves to a predetermined point. In this way, the conveying vehicle 18 repeats the conveying of the slag.

In this way, the slag discharge system 20 mixes the slag with the water and supplies the slag to the slag storage tank 30 in the slurry state, thereby conveying the slag to the slag storage tank 30. Since the slag discharge system 20 conveys the slag in the slurry state, the degree of freedom in the path of the pipe may be improved. That is, even when the conveying path is not formed in a linear shape and the inclination angle of the conveying path is an arbitrary angle, the slag may be conveyed. Accordingly, the system may be disposed in a compact size.

Further, the slag discharge system 20 discharges the water (the liquid) by installing the filters 106 and 108 at the side surfaces of the slag storage tank 30, thereby efficiently and simply discharging the water which is used for conveying the slag from the slag storage tank 30. Further, the water which is used for the conveying may be efficiently used by collecting the water discharged from the filters 106 and 108 of the slag storage tank 30 and returning the water to the slurry tank 40. Further, even when a part of the slag is discharged from the filters 106 and 108, the slag may be supplied to the slag storage tank 30 again as the slurry, and hence the slag may be conveyed without any waste.

In addition, in the slag storage tank 30 of the slag discharge system 20, the filter 106 and/or the filter 108 are disposed in at least a part of the cross-section perpendicular to the vertical direction of the main body 101. Thus, even when the liquid level (the water surface) reaches any position of the main body 101, the water surface may contact the filter 106 and/or the filter 108. Accordingly, it is possible to stabilize the amount of the water which is discharged from the slag storage tank 30. That is, it is possible to stabilize the amount of the water which is supplied (returned) from the slag storage tank 30 to the slurry tank 40. In this way, since the amount of the water collected from the slag storage tank 30 is stabilized, it is possible to set the amount of the water retained by the slurry tank 40 in a predetermined range and hence to set the concentration of the slag of the slurry sent from the slurry tank 40 to the slag storage tank 30 in a predetermined concentration range.

In this way, since the slag discharge system 20 may set the concentration of the slag in the slurry in a predetermined concentration range, it is possible to prevent a problem in which the concentration of the slag increases so that the slurry may not be conveyed. For example, the concentration of the slag in the slurry may be maintained at 40% or less, and hence the slag may be appropriately conveyed from the slurry tank 40 to the slag storage tank 30. Further, since the slag discharge system 20 may set the concentration of the slag in the slurry in a predetermined concentration range, the slag may be efficiently conveyed. That is, the amount of the slag included in the slurry decreases, and hence degradation in the conveying efficiency may be prevented. Furthermore, since the range of the concentration of the slag in the slurry may be various values depending on the configuration of the system or the performance of the pump, the range is not particularly limited. However, for example, the range of 5% to 40% is desirable.

Further, since the slag storage tank 30 reinforces the wall surface of the main body 101 by installing the reinforcing portion (the transverse reinforcing portion 112 and the longitudinal reinforcing portion 114), the strength of the slag storage tank 30 may be improved, and hence the durability may be improved. Further, the strength of the main body 101 may be decreased, and hence the cost of the system may be decreased.

The slag discharge system 20 may control the supply of the slag to the slurry tank 40 by controlling the driving of the conveyor 26b of the slag cooling unit 26. Further, the supply of the slag to the slurry tank 40 may be constantly controlled. Further, the slag discharge system 20 may further install a mechanism for supplying the water to the slurry tank 40 and a mechanism for controlling the supply of the water. Accordingly, the slurry retained in the slurry tank 40 may be further appropriately controlled.

Furthermore, in the embodiment, the water is used as the liquid which causes the slag to be in the slurry state, but any liquid other than the water may be used as long as the liquid is used.

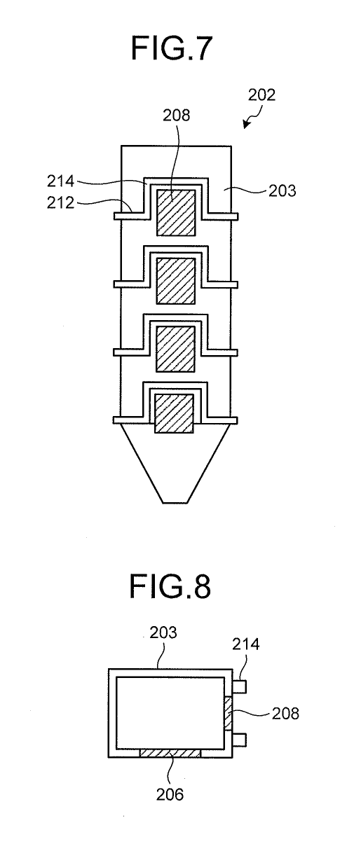

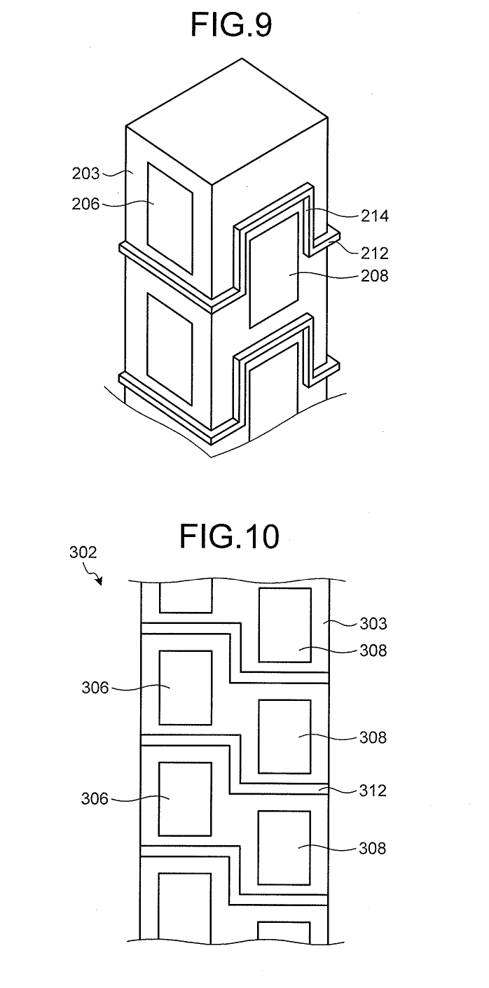

Here, the slag storage tank is not limited to the above-described embodiment. Hereinafter, another example of the slag storage tank will be described by using FIGS. 6 to 9. FIG. 6 is a side view illustrating a schematic configuration of another example of the slag storage tank. Further, FIG. 7 is a side view illustrating a side surface adjacent to the side surface of the slag storage tank illustrated in FIG. 6, FIG. 8 is a cross-sectional view taken along a line B-B of FIG. 6, and FIG. 9 is a perspective view illustrating a schematic configuration of the slag storage tank illustrated in FIG. 6. As illustrated in FIGS. 6 to 9, a slag storage tank 202 includes a main body 203, filters 206 and 208, and a reinforcing portion 212. Furthermore, the slag storage tank 202 may further include a trough. The main body 203 is a hollow tower, and in the embodiment, has a barrel shape of which the cross-section (the horizontal plane) has a square shape. Then, the lower side of the vertical direction is provided with an end of which the diameter gradually decreases.

The plurality of the filters 206 are arranged on the side surface (the wall surface) of the main body 203. The plurality of filters 206 are arranged at respective positions of one surface of the main body 203 in the vertical direction. Further, the plurality of filters 208 are arranged on the side surface (the wall surface) of the main body 203. The plurality of filters 208 are arranged at respective positions in the vertical direction of one surface adjacent to the surface provided with the filter 206 of the main body 203. Furthermore, each of the filters 206 and 208 has the same configuration as those of the filters 106 and 108.

Further, the position of the filter 208 in the vertical direction is different from the position of the filter 206 as in the filter 108. Specifically, the filter 208 is disposed in the vertical direction so as to be positioned at a region between the filter 206 and the filter 206 adjacent to the filter 206 in the vertical direction.

The reinforcing portion 212 is a bar-like member which is disposed in the circumferential direction of the main body 203, and the plurality of reinforcing portions are arranged on the outer peripheral surface of the main body 203. One reinforcing portion 212 is connected in the circumferential direction of the main body 203. Further, the reinforcing portion 212 is disposed in a linear shape between the filter 206 and the filter 206 in a surface provided with the filter 206 of the main body 203. The reinforcing portion 212 is disposed as a U-shaped portion 214 which is bent along the periphery of the filter 208 in the surface provided with the filter 208 of the main body 203. That is, the reinforcing portion 212 is basically disposed in a linear shape in the circumferential direction of the main body 203, and the portion overlapping the filter 208 is disposed in a shape (the U-shaped portion 214) which is bent along the periphery of the filter 208.

The slag storage tank 202 has the above-described configuration. Then, when the slag and the water are supplied from the slag conveying unit 28, only the water is discharged from the filters 206 and 208 and the slag is stored in the slag storage tank. Further, as illustrated in FIGS. 6 and 7, even in the slag storage tank 202, the filter 206 and the filter 208 are respectively disposed on different surfaces of the main body 203. Further, as illustrated in FIG. 8, a part of the cross-section perpendicular to the vertical direction of the main body 203 is provided with both the filter 206 and the filter 208. Accordingly, as illustrated in FIG. 9, the main body 203 is provided with the filter 206 and the filter 208 which are deviated from each other by a predetermined distance in the vertical direction. Further, the reinforcing portions 212 which are installed in the respective surfaces of the main body 203 are arranged at positions where the reinforcing portions do not overlap the filters 206 and 208.

Even when the reinforcing portion 212 is provided on the circumference so as to avoid the filter as in the slag storage tank 202, the strength of the slag storage tank 202 may be improved. Further, even when the reinforcing portion is provided so as to be deviated from the filter, the main body 203 may be reinforced without installing the longitudinal reinforcing portion by forming the reinforcing portion in a bent shape as in the reinforcing portion 212.

Next, still another example of the slag storage tank will be described by using FIGS. 10 to 12. Here, FIGS. 10, 11, and 12 are side views respectively illustrating a schematic configuration of another example of the slag storage tank. Furthermore, FIGS. 10, 11, and 12 are examples in which one surface of the main body is provided with the filter. Hereinafter, a relation between the filter and the reinforcing portion will be described.

In a slag storage tank 302 illustrated in FIG. 10, one surface of a main body 303 is provided with a plurality of filters 306 and a plurality of filters 308. Furthermore, the filters 306 are arranged in series in the vertical direction, and the filters 308 are also arranged in series in the vertical direction. Further, the filter 306 and the filter 308 are adjacent to each other in the horizontal direction.

Further, a reinforcing portion 312 is disposed at a position where the reinforcing portion passes between the filter 306 and the adjacent filter 306 and between the filter 308 and the adjacent filter 308. Further, the portion of the reinforcing portion 312 passing between the filter 306 and the adjacent filter 306 and the portion thereof passing between the filter 308 and the adjacent filter 308 are connected to each other by the bar-like portion which extends in the vertical direction between the filter 306 and the filter 308. Accordingly, the reinforcing portion 312 extends around the main body 303 in the circumferential direction.

As illustrated in the slag storage tank 302, one surface is provided with the plurality of filters which are adjacent to each other in the horizontal direction, that is, two filters which are arranged in series. Here, even when one filter of the adjacent filters in the horizontal direction is provided in a region without the other filter, the filter may be disposed at any position in the vertical direction.

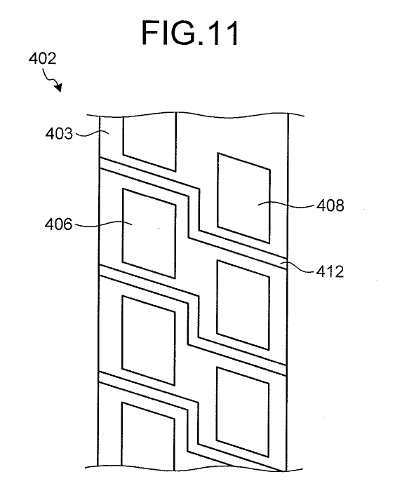

In a slag storage tank 402 illustrated in FIG. 11, one surface of a main body 403 is provided with a plurality of filters 406 and a plurality of filters 408. Furthermore, the filters 406 are arranged in series in the vertical direction, and the filters 408 are also arranged in series in the vertical direction. Further, the filter 406 and the filter 408 are adjacent to each other in the horizontal direction. Here, the filter 406 and the filter 408 are all formed in a parallelogram shape, that is, a shape in which the area decreases as the position in the vertical direction and particularly, the end in the up and down direction goes to the end. Further, in the filter 406 and the filter 408, the region where the filter 406 and the filter 408 overlap each other in the vertical direction becomes a region of which the area changes.

Further, a reinforcing portion 412 is disposed at a position where the reinforcing portion passes between the filter 406 and the adjacent filter 406 and between the filter 408 and the adjacent filter 408. Further, the reinforcing portion 412 is inclined along the sides of the ends of the filters 406 and 408 in the vertical direction. Further, the portion of the reinforcing portion 412 passing between the filter 406 and the adjacent filter 406 and the portion thereof passing between the filter 408 and the adjacent filter 408 are connected to each other by the bar-like portion which extends in the vertical direction between the filter 406 and the filter 408. Accordingly, the reinforcing portion 412 extends around the main body 403 in the circumferential direction.

As in the slag storage tanks 30, 202, and 302, in the slag storage tank 402, one surface is provided with a plurality of filters adjacent to each other in the horizontal direction, that is, two filters arranged in series. Here, since one filter of the filters adjacent to each other in the horizontal direction is provided in a region without the other filter, the filter may be disposed in any position in the vertical direction.

In addition, in the slag storage tank 402, the shape of the filter is formed in a shape in which the area changes in accordance with the position in the vertical direction, thereby decreasing a difference in the area of the filter in the cross-section between the region where the filter and the other filter overlap each other and the region where the filter and the other filter do not overlap each other. Accordingly, it is possible to further decrease a change in the area (the area in the cross-section) of the filter in the vertical direction, and hence to decrease a change in the amount of the water discharged from the slag storage tank 402.

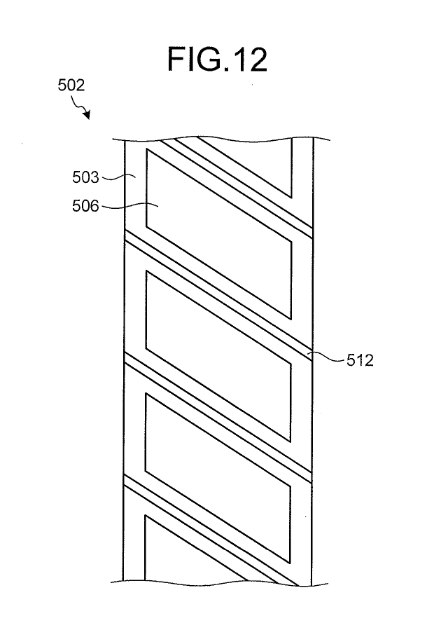

In a slag storage tank 502 illustrated in FIG. 12, one surface of a main body 503 is provided with a plurality of filters 506. The filters 506 are arranged in series in the vertical direction. The filter 506 is formed in a parallelogram shape, that is, a shape in which the area decreases as the position in the vertical direction, and particular, the end in the up and down direction goes to the end. Further, a part of the filters 506 are arranged on the same horizontal plane as that of the other filters 506 which are adjacent to each other in the vertical direction. That is, the lower end of the filter 506 in the vertical direction is positioned at the lower side in the vertical direction in relation to the upper end of the filter 506 in the vertical direction adjacent to the lower side in the vertical direction. The upper end of the filter 506 in the vertical direction is positioned at the upper side in the vertical direction in relation to the lower end of the filter 506 in the vertical direction adjacent to the upper side in the vertical direction.

Further, a reinforcing portion 512 is disposed at a position where the reinforcing portion passes between the filter 506 and the adjacent filter 506. Further, the reinforcing portion 512 extends around the main body 503 in the circumferential direction.

In the slag storage tank 502, the filter 506 is formed in a shape in which the area changes in accordance with the position in the vertical direction, and particularly, the position in the up and down direction. Accordingly, even when the filters 506 are arranged in series on one surface, a shape may be obtained in which a part of the filters 506 and a part of the adjacent filters 506 overlap each other in the horizontal direction by adjusting the shape of the filter 506 in the horizontal direction.

In this way, in the slag storage tank, the arrangement position and the shape of the filter may be variously changed. Furthermore, in the slag storage tank, the filters may be installed on three or more surfaces of the main body and may be arranged at random while not being arranged in series.

Furthermore, in the slag storage tank, the area of the filter, that is, the ratio of the filter with respect to the cross-section is desirably in a predetermined range and is more desirably set to a predetermined value even in any cross-section of the cross-section perpendicular to the vertical direction of the main body. That is, it is desirable to further decrease the amount of a change in the area of the filter which changes in accordance with the position in the vertical direction in the slag storage tank. The slag storage tank may further stably discharge the liquid conveyed as the slurry to the outside by decreasing a change in the area of the filter in the vertical direction.

### INDUSTRIAL APPLICABILITY

As described above, the slag storage tank and the slag discharge system according to the invention are useful for storing and discharging the slag, and are particularly, suitable for cooling the slag produced by the combustion furnace and discharging the slag to a predetermined position.

### REFERENCE SIGNS LIST

12 gasification furnace
14 slag hopper
16 opening and closing valve
18 conveying vehicle
20 slag discharge system
22 slag lock hopper
26 slag cooling unit
26a cooling tank
26b conveyor
28 slag conveying unit
30 slag storage tank
32 discharge port
40 slurry tank
42 transport pipe
43 slurry pump
62 collection pipe
63a, 63b water receiving portion
101 main body
106, 108 filter
109, 110 trough
112 transverse reinforcing portion
114 longitudinal reinforcing portion

1. A slag storage tank for storing slag, comprising:
a main body which stores slag; and
a plurality of filters which are arranged on a wall surface of the main body and cause a liquid to selectively pass therethrough,
wherein the filters are arranged in at least a part of any cross-section perpendicular to the vertical direction of the wall surface in a region where the slag is stored in the main body.

2. The slag storage tank according to claim 1, further comprising a reinforcing portion which is disposed around the outer periphery of the main body.

3. The slag storage tank according to claim 1,
wherein the main body includes a plurality of surfaces, and
wherein the filters are arranged on a same surface of the main body.

4. The slag storage tank according to claim 1,
wherein the main body includes a plurality of surfaces, and
wherein the filters are arranged on the plurality of surfaces of the main body.

5. The slag storage tank according to claim 1, wherein a ratio of the filters arranged on the cross-section perpendicular to the vertical direction in the area where the slag is stored in the main body is in a predetermined range.

6. A slag storage tank for storing slag, comprising:
a main body which stores slag; and
a plurality of filters which are arranged on a wall surface of the main body and cause a liquid to selectively pass therethrough,
wherein rows of the plurality of filters arranged in the vertical direction of the main body are arranged at adjacent positions in the horizontal direction of the main body, and
wherein the filters are arranged so that the positions in the vertical direction are shifted from the filters arranged in the adjacent rows.

7. A slag discharge system comprising:
the slag storage tank according to claim 1;
a slag cooling unit which cools discharged slag;
a slurry tank which stores the slag discharged from the slag cooling unit and a liquid;
a slag slurry conveying unit which changes the slag stored in the slurry tank into slurry by the liquid and conveys the slurry to the slag storage tank; and
a collection unit which collects the liquid discharged from the filter of the slag storage tank and supplies the liquid to the slurry tank.
